(19) United States
(12) Patent Application Publication
(10) Pub. No.: US 2006/0040529 A1
(43) Pub. Date: Feb. 23, 2006

(54) Main board and fixing component thereof

(75) Inventors: Kevin Kuo, Shindian City (TW); James Hsyu, Shindian City (TW); Langhans Chang, Shindian City (TW)

Correspondence Address: BACON & THOMAS, PLLC, 625 SLATERS LANE, FOURTH FLOOR, ALEXANDRIA, VA, 22314, US

(73) Assignee: VIA Technologies, Inc., Shindian City (TW)

(21) Appl. No.: 11/036,010

(22) Filed: Jan. 18, 2005

(30) Foreign Application Priority Data
Aug. 20, 2004 (TW) 093125297

(51) Int. Cl. H01R 12/00

(52) U.S. Cl. 439/82

(57) ABSTRACT

A fixing component of a main board comprises a connecting part, a thread-assembling part and a fixing part. The connecting part has a first surface and a second surface, wherein the first surface is disposed opposite to the second surface. The thread-assembling part is disposed on the first surface of the connecting part. The fixing part is disposed on the second surface. The connecting part and the fixing part are disposed on a main board by utilizing DIP technology and SMT.

### BACKGROUND OF THE INVENTION

1. Field of Invention

The invention relates to a main board and a fixing component thereof and, in particular, to a fixing component, which is disposed on a main board by utilizing the surface mounted technology (SMT) and dual inline package (DIP) technology.

2. Related Art

In general, there are many bosses with different size disposed on the main board. The efficiency of these bosses is to cooperate with a case to fix the main board or to fix other additional elements, which must be fixed on the main board. Due to the development of the main board with stronger and stronger functions, layouts on the main board are also more and more complicated. However, the boss will occupy some layout spaces, which results in the problems of the layout design. Correspondingly, the difficulty of designing the placement of the bosses is increased.

Referring to FIG. 1A, the combination method of the conventional boss includes the following steps of: forming a plurality of circular opening 13 on a main board 10, and then combining a hexagonal boss (female) 11 with a screw 12, which are positioned at the two side of the main board 10, via the circular opening 13. In addition, referring to FIG 1B, the combination method may include the following steps of: forming a plurality of circular opening 13 on the main board 10, and then combining a hexagonal boss (male) 11′ with a hexagonal nut 14, which are positioned at the two side of the main board 10, via the circular opening 13.

However, the above-mentioned combination method needs to manually assemble the boss with the screw or the nut, so that it wastes many labor costs and time. Furthermore, if the elements of the product are unstable combined caused by artificial faults, the product may have element separations in the later usage. In addition, the circular opening on the main board for the combination of the boss is usually utilized as a ground point, which can provide one solution of the Electromagnetic Interference (EMI). However, since the contact area of the boss and the ground point is not enough, this solution may not prevent the EMI efficiently.

As mentioned above, the conventional fixing component of the main board is composed of the hexagonal boss and the screw or the nut. It occupies more area on the main board, so that the layout design becomes harder. Besides, this solution needs to manually combine the elements, which results in the increase of production costs. It is therefore a subjective of the invention to decrease the occupied space of the fixing component on the main board for the more and more complicated layout of the main board, and to shorten the producing time for saving labor costs and time.

### SUMMARY OF THE INVENTION

In view of the above, the invention is to provide a fixing component, which is disposed on a main board by utilizing SMT and DIP technology.

To achieve the above, a fixing component of a main board of the invention comprises a connecting part, a thread-assembling part, and a fixing part. In the invention, the connecting part has a first surface and a second surface, which is opposite to the first surface. The thread-assembling part is disposed on the first surface of the connecting part. The fixing part is disposed on the second surface of the connecting part. The connecting part and the fixing part is respectively disposed on a circuit board by using SMT and DIP technology.

In addition, the invention also discloses a main board, which comprises a circuit board and at least one fixing component. In the invention, the circuit board has at least a non-circular opening. The fixing component is disposed on the circuit board by using SMT and DIP technology. The connecting part has a first surface and a second surface, which is opposite to the first surface. The thread-assembling part is disposed on the first surface of the connecting part. The fixing part is disposed on the second surface of the connecting part and is connected with the circuit board.

As mentioned above, the fixing component of the main board of the invention is disposed on the main board by utilizing SMT and DIP technology, and has a fixing part requiring a smaller opening on the main board than that of prior art. Therefore, the occupied space on the main board can be reduced, and the disposition of the fixing component can be integrated in a production line with utilizing the SMT and DIP technology. Accordingly, the layout space can be increased and the labor costs can be saved.

### BRIEF DESCRIPTION OF THE DRAWINGS

The invention will become more fully understood from the detailed description given herein below illustration only, and thus is not limitative of the present invention, and wherein:

FIG. 1A and FIG 1B are schematic diagrams showing the conventional fixing component of the main board;

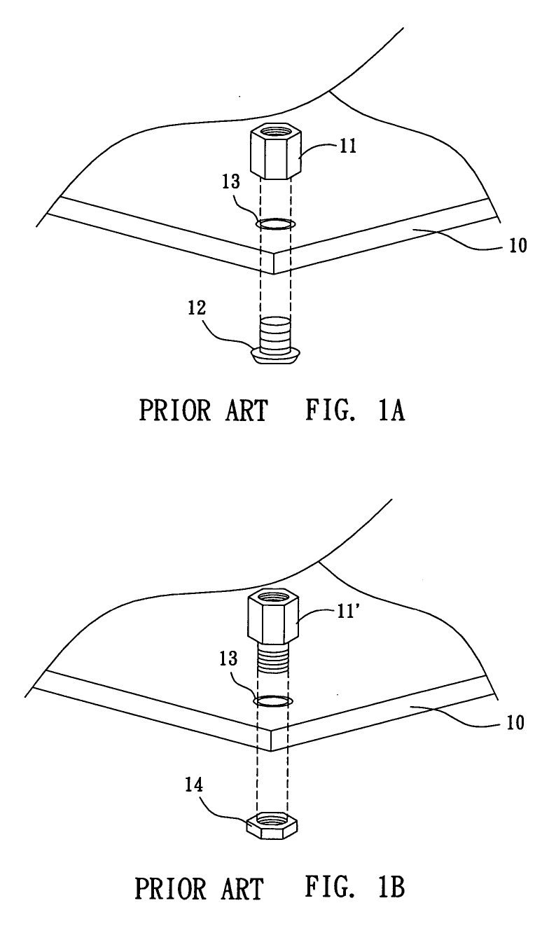

FIG. 2A and FIG. 2B are schematic diagrams showing a fixing component of a main board according to an embodiment of the invention;

FIG. 3 is a lateral view showing a fixing component of a main board according to an embodiment of the invention; and

FIGS. 4A and 4B are schematic diagrams showing a main board according to an embodiment of the invention.

### DETAILED DESCRIPTION OF THE INVENTION

The main board and the fixing component thereof of the present invention will be apparent from the following detailed description, which proceeds with reference to the accompanying drawings, wherein the same references relate to the same elements.

A fixing component 3 of a main board according to a preferred embodiment of the invention comprises a connecting part 31, a thread-assembling part 32, and a fixing part 33.

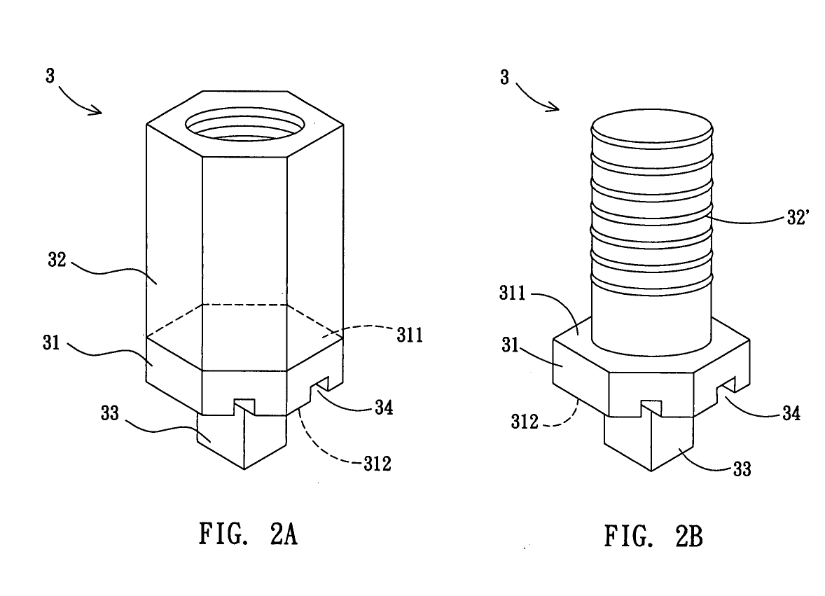

Referring to FIG. 2A, in this embodiment, the materials of the connecting part 31, the thread-assembling part 32, and the fixing part 33 are conductivity materials. The connecting part 31 has a first surface 311 and a second surface 312, which is disposed opposite to the first surface 311 and is formed with at least a groove 34 thereon.

The thread-assembling part 32 is disposed on the first surface 311 of the connecting part 31. In this embodiment, the thread-assembling part 32 is a female thread-assembling part, which is used to connect with an additional element. Alternatively, the thread-assembling part of the invention can be a male thread-assembling part 32′ as shown in FIG. 2B.

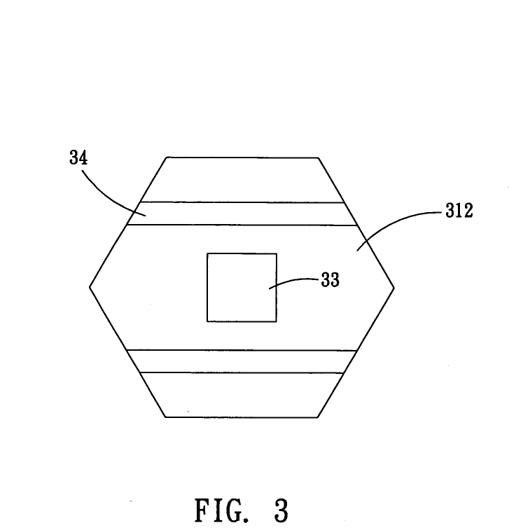

The fixing part 33 is disposed on the second surface 312 of the connecting part 31, and the connecting part 31 is disposed on a circuit board by utilizing SMT. The fixing part 33 is a non-circular pillar or a polygonal pillar, and is disposed on the circuit board by utilizing DIP technology. In this embodiment, the fixing part 33 is a rectangular pillar. In addition, referring to FIG. 3, the groove 34, which is formed on the second surface 312 of the connecting part 31, is disposed adjacent to the fixing part 33.

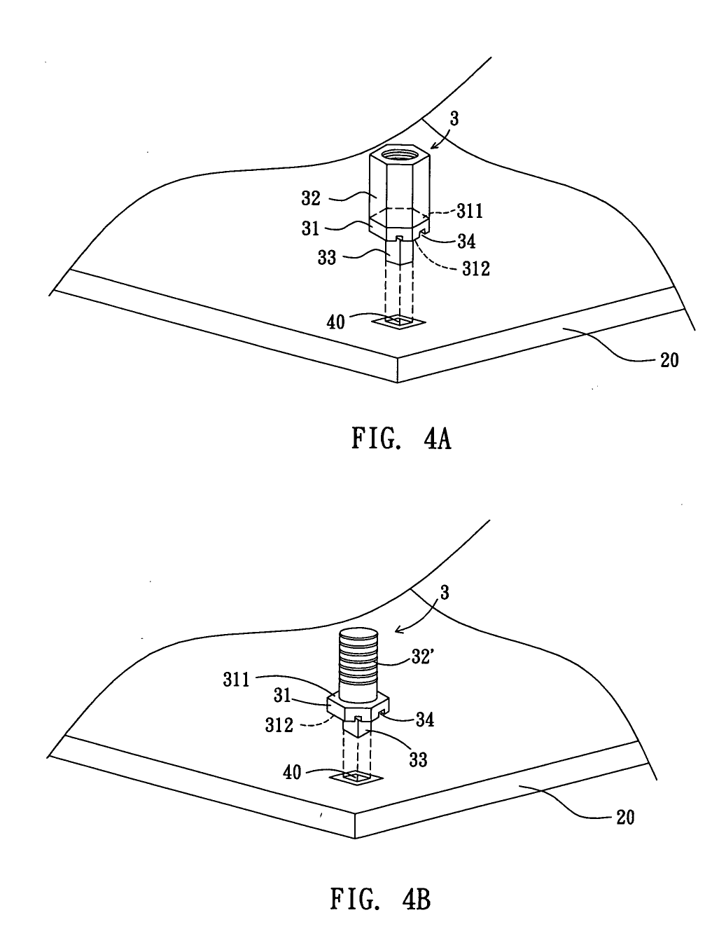

The main board of the invention will be described herein below according to FIG. 4A.

Referring to FIG. 4A, a main board according to an embodiment of the invention comprises a circuit board 20 and at least one fixing component 3. The circuit board 20 has at least one non-circular opening 40, which is used to connect or electrically connect with the fixing component 3. In this embodiment, the non-circular opening 40 is a rectangular opening, and certainly, the non-circular opening 40 can be a polygonal opening.

The fixing component 3 is disposed around the non-circular opening 40 of the circuit board 20 by utilizing SMT, and then the DIP process is performed to enhance the strength of the fixing component 3 disposed on the circuit board 20. The fixing component 3 comprises a connecting part 31, a thread-assembling part 32, and a fixing part 33.

In this embodiment, the connecting part 31, the thread-assembling part 32, and the fixing part 33 are integrally formed and the connecting part 31, the thread-assembling part 32, and the fixing part 33 are made of conductivity materials. The connecting part 31 has a first surface 311 and a second surface 312, which is disposed opposite to the first surface 311 and is formed with at least one groove 34 thereon. In addition, the connecting part 31 is disposed on the circuit board 20 by utilizing SMT.

The thread-assembling part 32 is disposed on the first surface 311 of the connecting part 31. In this embodiment, the thread-assembling part 32 is a female thread-assembling part. Alternatively, the thread-assembling part of the embodiment can be a male thread-assembling part 32′ as shown in FIG. 4B. In the present embodiment, the circuit board 20 is connected with an additional element via the fixing component 3 and the additional element is combined with the thread-assembling part 32.

The fixing part 33, which is a non-circular pillar, is disposed on the second surface 312 of the connecting part 31. In this embodiment, the fixing part 33 is a rectangular pillar, which is used to electrically connect with the rectangular opening of the circuit board 20. After the connecting part 31 is disposed on the circuit 20 by utilizing SMT, the strength of the fixing part 33 is enhanced with DIP technology. Additionally, referring to FIG. 3, the groove 34, which is formed on the second surface 312 of the connecting part 31, is disposed adjacent to the fixing part 33. The design of the groove 34 provides a space to accommodate the overflowed solder when performing SMT, so as to reduce the problem caused by the overflowed solder.

In summary, the fixing component of the main board of the invention has the fixing part, e.g. the non-circular pillar, disposed in the non-circular opening of the circuit board, so that the enhanced torque can be obtained between the fixing component and the circuit board. In addition, since the SMT and DIP technology are employed, which utilize solder to electrically connect the fixing component and the circuit board, the effect of grounding of the invention is better than that of prior art, which combines the boss with the screw or nut. Furthermore, since the fixing component is combined with the circuit board by utilizing SMT and DIP technology, the assembling process of the fixing component and circuit board can be integrated with other SMT and DIP processes. Thus, the time and manpower for this assembling process can be saved, and the space occupied by the fixing component can be reduced. Accordingly, the fixing component of the invention is suitable for the present main board, which has the more and more complicated layout.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A main board, comprising:
a circuit board; and
at least a fixing component, which is disposed on the circuit board, and comprises:
a connecting part, which has a first surface and a second surface, wherein the first surface is disposed opposite to the second surface,
a thread-assembling part, which is disposed on the first surface of the connecting part, and
a fixing part, which is disposed on the second surface of the connecting part and is connected with the circuit board.

2. The main board according to claim 1, wherein the connecting part, the thread-assembling part, and the fixing part are integrally formed.

3. The main board according to claim 1, wherein the thread-assembling part is a female thread-assembling part or a male thread-assembling part.

4. The main board according to claim 1, wherein the circuit board has at least one non-circular opening, and the fixing part is a non-circular pillar and is embedded in the non-circular opening of the circuit board by utilizing surface mounted technology (SMT).

5. The main board according to claim 4, wherein the fixing part is a rectangular pillar and the non-circular opening of the circuit board is a rectangular opening.

6. The main board according to claim 4, wherein the fixing part is a polygonal pillar and the non-circular opening of the circuit board is a polygonal opening.

7. The main board according to claim 1, wherein the fixing component comprises a conductivity material, and is electrically connected with the circuit board.

8. The main board according to claim 1, wherein the second surface of the connecting part is formed with at least one groove, and the groove is disposed adjacent to the fixing part.

9. The main board according to claim 1, wherein the circuit board is connected with an additional element via the fixing component, and the additional element is assembled with the thread-assembling part.

10. The main board according to claim 1, wherein the fixing component is disposed on the circuit board by utilizing SMT and is enhanced with using DIP technology.

11. A fixing component of a main board, comprising:
a connecting part, which has a first surface and a second surface, wherein the first surface is disposed opposite to the second surface;
a thread-assembling part, which is disposed on the first surface of the connecting part; and
a fixing part, which is disposed on the second surface of the connecting part.

12. The fixing component according to claim 11, wherein the connecting part, the thread-assembling part, and the fixing part are integrally formed.

13. The fixing component according to claim 11, wherein the thread-assembling part is a female thread-assembling part or a male thread-assembling part.

14. The fixing component according to claim 11, wherein the fixing part is a non-circular pillar.

15. The fixing component according to claim 14, wherein the fixing part is a rectangular pillar.

16. The fixing component according to claim 14, wherein the fixing part is a polygonal pillar.

17. The fixing component according to claim 11, wherein the material of the connecting part, the thread-assembling part, and the fixing part are the conductivity material.

18. The fixing component according to claim 11, wherein the second surface of the connecting part is formed at least one groove, which is disposed adjacent to the fixing part.

19. The fixing component according to claim 11, wherein the thread-assembling part is used to combine with an additional element.

20. The fixing component according to claim 11, wherein the fixing component is disposed on a circuit board by utilizing SMT and is enhanced with using DIP technology.
